(19) United States
(12) Patent Application Publication
(10) Pub. No.: US 2019/0347715 A1
(43) Pub. Date: Nov. 14, 2019

(54) ON-LINE BANKING DEVICE, SYSTEM AND METHOD

(71) Applicant: Zolla Financial LLC, Roseville, CA (US)

(72) Inventors: Adam Holt, Redding, CA (US); Matthew Piercey, Chicago, IL (US)

(21) Appl. No.: 16/408,261

(22) Filed: May 9, 2019

Related U.S. Application Data
(60) Provisional application No. 62/669,829, filed on May 10, 2018.

(51) Int. Cl. G06Q 40/02

(52) U.S. Cl. CPC G06Q 40/02

(57) ABSTRACT

Systems and methods perform real-time updating of an account balance based on real-time interest accrual. An account balance for an account is determined and displayed on a computing device. While the account balance is being displayed on the computing devices for a display time period, an updated account balance is determined and displayed based on an accrued interest. The accrued interest is calculated over a determined period of time based on the determined account balance and a determined interest rate. The determined period of time is less than the display time period but greater than zero. The updated account balance is determined based on the account balance and the accrued interest. A transitional animation from the determined account balance to the updated account balance is generated and employed to display the updated account balance on the computing device.

### BACKGROUND

### Technical Field

The present disclosure generally relates to display interfaces, such as a user-accessible user interfaces that display account information.

### Description of the Related Art

Most traditional bank accounts and other monetary fund accounts accrue at least some interest over time. This interest is generally accrued and compounded at an annual or semi-annual basis. Thus, when a user logs into their account, such as via a web portal, the user sees the current balance as of the last time the interest was added to the account balance.

### BRIEF SUMMARY

A device may be summarized as including one or more memories, which, in operation, store instructions; and one or more processing cores coupled to the one or more memories, which, in operation, execute instructions to perform actions. The action performed by the one or more processing cores include: determining an account balance for an account; displaying the account balance on a computing device; and while the account balance is being displayed on the computing device for at least a display time period: determining an accrued interest over a determined period of time based on the account balance and a determined interest rate, wherein the determined period of time is shorter than the display time period and greater than zero; determining an updated account balance for the account based on the account balance and the accrued interest; and updating the display of the account balance by displaying a transitional animation from the account balance to the updated account balance. The determined period of time may be less than one second but greater than zero seconds.

Determining the updated account balance may include determining a real-time balance for display without updating a ledger entry for the account. Determining the accrued interest, determining the updated account balance, and updating the display of the account balance may include: providing, to the computing device, the account balance, the determined interest rate, a number of times interest is compounded per year, and an amount of time that has passed since the account balance was determined; and instructing the computing device to compute the updated account balance for the determined period of time and update the display of the account balance by displaying the transitional animation from the account balance to the updated account balance.

The one or more processing cores, in operation, may execute the instructions to perform actions including: pausing the displaying of the updated account balance for a determined pause period prior to displaying a second updated account balance based on the updated account balance; during the determined pause period: determining a second accrued interest based on the updated account balance and the determined interest rate; determining the second updated account balance for the account based on the updated account balance and the second accrued interest; and in response to an end of the determined pause period, updating the display of the updated account balance by displaying the transitional animation from the updated account balance to the second updated account balance. The one or more processing cores, in operation, may execute the instructions to perform actions including: determining a least significant digit and a more significant digit that changed values between the account balance and the updated account balance; and employing the transitional animation to update the least significant digit from a first value for the account balance to a second value for the updated account balance at a first rate that is faster than a second rate for updating the more significant digit from a third value for the account balance to a forth value for the updated account balance.

The one or more processing cores, in operation, may execute the instructions to perform actions including: receiving a non-interest increase in the account balance; and determining the updated account balance based on the account balance, the non-interest increase, and the accrued interest. The one or more processing cores, in operation, may execute the instructions to perform actions including: determining that the updated account balance includes more digits than the account balance; updating the display of the account balance by right shifting the displayed account balance based on a change in a number of digits between the account balance and the updated account balance; and employing the transition animation from the account balance to the updated account balance by updating each digit of the updated account balance from the account balance to the updated account balance.

The one or more processing cores, in operation, may execute the instructions to perform actions including: determining that a change between the account balance and the updated account balance is less than one cent; and updating the display of the account balance to include micro-cents. The one or more processing cores, in operation, may execute the instructions to perform actions including: determining that a change between the account balance and the updated account balance is greater than one cent; and updating the display of the account balance to remove a display of micro-cents. The one or more processing cores, in operation, may execute the instructions to perform actions including: updating the ledger entry at a second determined period of time that is longer than the determined period of time or in response to a deposit or withdrawal from the account.

The one or more processing cores, in operation, may execute the instructions to perform actions including: displaying a counter from when the updated account balance was determined to when a second updated account balance is to be determined.

A method may be summarized as including determining an account balance for an account; displaying the account balance on a computing device; and while the account balance is being displayed on the computing device for at least a display time period: determining an accrued interest over a determined period of time based on the account balance and a determined interest rate, wherein the determined period of time is shorter than the display time period and greater than zero; determining an updated account balance for the account based on the account balance and the accrued interest; and updating the display of the account balance by displaying a transitional animation from the account balance to the updated account balance. The determined period of time may be less than one second but greater than zero seconds.

Determining the updated account balance may include determining a real-time balance for display without updating a ledger entry for the account. Determining the accrued interest, determining the updated account balance, and updating the display of the account balance may include: providing, to the computing device, the account balance, the determined interest rate, a number of times interest is compounded per year, and an amount of time that has passed since the account balance was determined; and instructing the computing device to compute the updated account balance for the determined period of time and update the display of the account balance by displaying the transitional animation from the account balance to the updated account balance.

The method may include pausing the displaying of the updated account balance for a determined pause period prior to displaying a second updated account balance based on the updated account balance; during the determined pause period: determining a second accrued interest based on the updated account balance and the determined interest rate; determining the second updated account balance for the account based on the updated account balance and the second accrued interest; and in response to an end of the determined pause period, updating the display of the updated account balance by displaying the transitional animation from the updated account balance to the second updated account balance.

The method may include determining a least significant digit and a more significant digit that changed values between the account balance and the updated account balance; and employing the transitional animation to update the least significant digit from a first value for the account balance to a second value for the updated account balance at a first rate that is faster than a second rate for updating the more significant digit from a third value for the account balance to a forth value for the updated account balance. The method may include receiving a non-interest increase in the account balance; and determining the updated account balance based on the account balance, the non-interest increase, and the accrued interest.

The method may include determining that the updated account balance includes more digits than the account balance; updating the display of the account balance by right shifting the displayed account balance based on a change in a number of digits between the account balance and the updated account balance; and employing the transition animation from the account balance to the updated account balance by updating each digit of the updated account balance from the account balance to the updated account balance. The method may include determining that a change between the account balance and the updated account balance is less than one cent; and updating the display of the account balance to include micro-cents.

The method may further include determining that a change between the account balance and the updated account balance is greater than one cent; and updating the display of the account balance to remove a display of micro-cents. The method may include updating the ledger entry at a second determined period of time that is longer than the determined period of time or in response to a deposit or withdrawal from the account. The method may include displaying a counter from when the updated account balance was determined to when a second updated account balance is to be determined.

A non-transitory computer-readable medium having contents that cause a processor to perform actions may be summarized as including determining an account balance for an account; displaying the account balance on a computing device; and while the account balance is being displayed on the computing device for at least a display time period: determining an accrued interest over a determined period of time based on the account balance and a determined interest rate, wherein the determined period of time is shorter than the display time period and greater than zero; determining an updated account balance for the account based on the account balance and the accrued interest; and updating the display of the account balance by displaying a transitional animation from the account balance to the updated account balance. The determined period of time may be less than one second but greater than zero seconds.

Determining the updated account balance may include determining a real-time balance for display without updating a ledger entry for the account. Determining the accrued interest, determining the updated account balance, and updating the display of the account balance may include: providing, to the computing device, the account balance, the determined interest rate, a number of times interest is compounded per year, and an amount of time that has passed since the account balance was determined; and instructing the computing device to compute the updated account balance for the determined period of time and update the display of the account balance by displaying the transitional animation from the account balance to the updated account balance.

The contents of the non-transitory computer-readable medium may cause the processor to perform actions, the actions including: pausing the displaying of the updated account balance for a determined pause period prior to displaying a second updated account balance based on the updated account balance; during the determined pause period: determining a second accrued interest based on the updated account balance and the determined interest rate; determining the second updated account balance for the account based on the updated account balance and the second accrued interest; and in response to an end of the determined pause period, updating the display of the updated account balance by displaying the transitional animation from the updated account balance to the second updated account balance.

The contents of the non-transitory computer-readable medium may cause the processor to perform actions, the actions including: determining a least significant digit and a more significant digit that changed values between the account balance and the updated account balance; and employing the transitional animation to update the least significant digit from a first value for the account balance to a second value for the updated account balance at a first rate that is faster than a second rate for updating the more significant digit from a third value for the account balance to a forth value for the updated account balance.

The contents of the non-transitory computer-readable medium may cause the processor to perform actions, the actions including: receiving a non-interest increase in the account balance; and determining the updated account balance based on the account balance, the non-interest increase, and the accrued interest. Contents may cause the processor to perform actions, the actions including: determining that the updated account balance includes more digits than the account balance; updating the display of the account balance by right shifting the displayed account balance based on a change in a number of digits between the account balance and the updated account balance; and employing the transition animation from the account balance to the updated account balance by updating each digit of the updated account balance from the account balance to the updated account balance.

The contents of the non-transitory computer-readable medium may cause the processor to perform actions, the actions including: determining that a change between the account balance and the updated account balance is less than one cent; and updating the display of the account balance to include micro-cents. Contents may cause the processor to perform actions, the actions including: determining that a change between the account balance and the updated account balance is greater than one cent; and updating the display of the account balance to remove a display of micro-cents. Contents may cause the processor to perform actions, the actions including: updating the ledger entry at a second determined period of time that is longer than the determined period of time or in response to a deposit or withdrawal from the account. The contents of the non-transitory computer-readable medium may cause the processor to perform actions, the actions including: displaying a counter from when the updated account balance was determined to when a second updated account balance is to be determined.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Moreover, some elements known to those of skill in the art have not been illustrated in the drawings for ease of illustration. One or more embodiments are described hereinafter with reference to the accompanying drawings in which:

FIG. 1 shows an embodiment of an overview environment that may be employed to facilitate providing on-line banking services;

FIG. 2 shows an embodiment of a computing system and environment that may be employed to facilitate on-line banking services;

FIGS. 3A-3D illustrate an example display of an embodiment of displaying continuous interest generation;

FIGS. 4A-4B illustrate an example display of an embodiment of displaying a step increase to an account balance;

FIG. 5 illustrates an example display of an embodiment of displaying micro-cents of an account balance;

FIGS. 6A-6B illustrate an example display of an embodiment of displaying continuous interest generation using micro-cents;

FIGS. 7A-7C illustrate example displays of an embodiment of indicating when a next compounding event is to occur to an account balance;

FIGS. 8A-8B illustrate an example display of a custom user interface that enables a user to dynamically allocate an investment among multiple funds;

FIG. 9 illustrates an example display of a custom user interface that enables a user to view fund allocation shifting;

FIG. 10A illustrates a logical flow diagram generally showing an embodiment of a process for displaying continuous interest generation;

FIG. 10B illustrates a logical flow diagram generally showing an embodiment of a process for enabling a user to dynamically allocate an investment among multiple funds;

FIG. 10C illustrates a logical flow diagram generally showing an embodiment of a process for enabling a user to view fund allocation shifting; and

FIG. 10D illustrates a logical flow diagram generally showing an embodiment of a process for providing reduced fund transfers among multiple users.

### DETAILED DESCRIPTION

In the following description, certain details are set forth in order to provide a thorough understanding of various embodiments of devices, systems, methods and articles. However, one of skill in the art will understand that other embodiments may be practiced without these details. In other instances, well-known structures and methods associated with, for example, mobile devices, etc., such as processing cores, memories, power supplies, buses, communication networks, etc., have not been shown or described in detail in some figures to avoid unnecessarily obscuring descriptions of the embodiments.

Unless the context requires otherwise, throughout the specification and claims which follow, the word “comprise” and variations thereof, such as “comprising,” and “comprises,” are to be construed in an open, inclusive sense, that is, as “including, but not limited to.”

Reference throughout this specification to “one embodiment,” or “an embodiment” means that a particular feature, structure or characteristic described in connection with the embodiment is included in at least one embodiment. Thus, the appearances of the phrases “in one embodiment,” or “in an embodiment” in various places throughout this specification are not necessarily referring to the same embodiment, or to all embodiments. Furthermore, the particular features, structures, or characteristics may be combined in any suitable manner in one or more embodiments to obtain further embodiments.

The headings are provided for convenience only, and do not interpret the scope or meaning of this disclosure.

The sizes and relative positions of elements in the drawings are not necessarily drawn to scale. For example, the shapes of various elements and angles are not drawn to scale, and some of these elements are enlarged and positioned to improve drawing legibility. Further, the particular shapes of the elements as drawn are not necessarily intended to convey any information regarding the actual shape of particular elements, and have been selected solely for ease of recognition in the drawings.

### Suitable Embodiments for Providing On-Line Banking Services

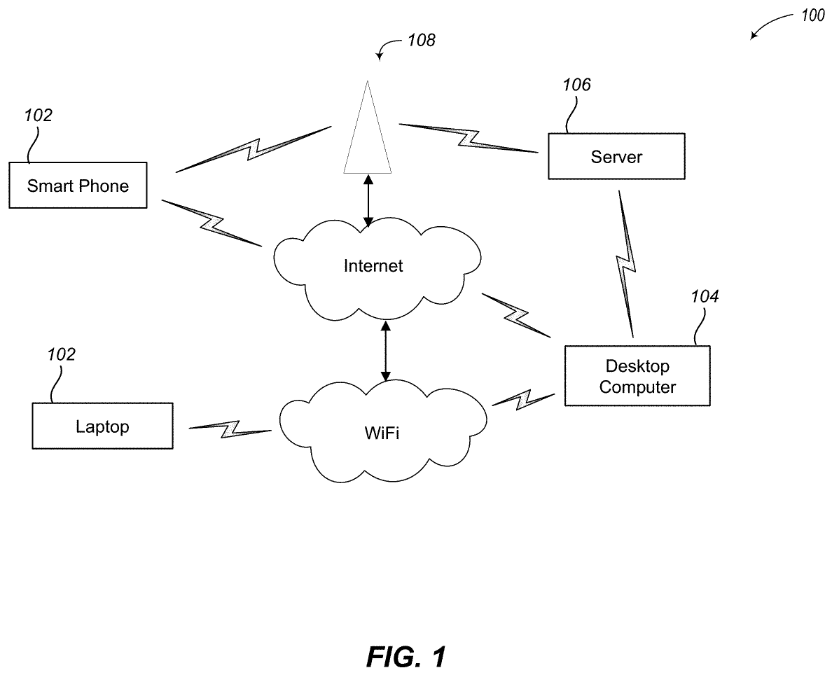

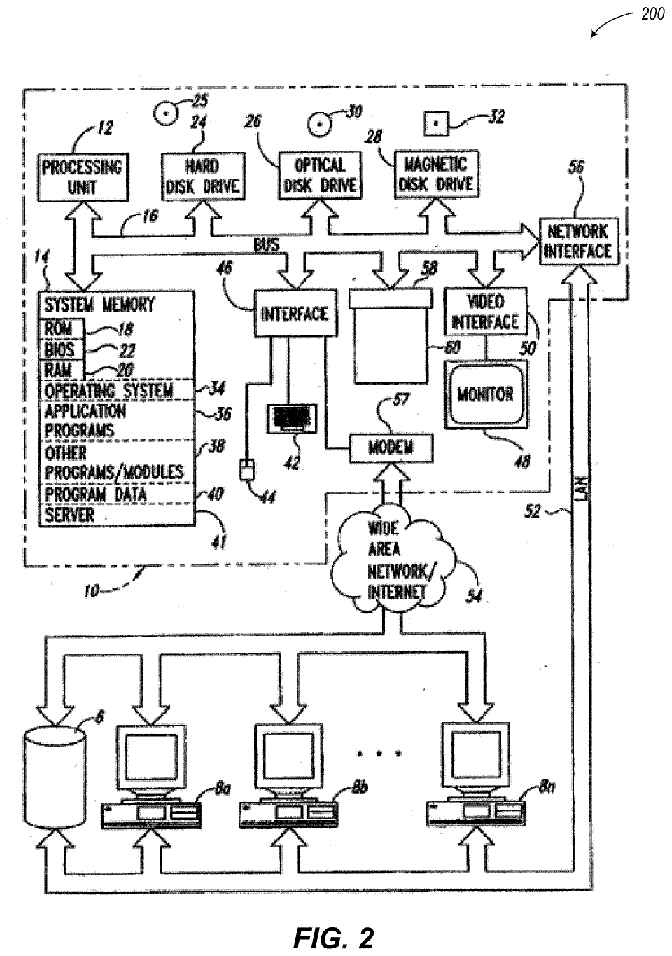

FIG. 1 shows an embodiment of an environment 100 that may be employed to facilitate providing on-line banking services as described herein, such as by performing one or more of the methods disclosed herein. The environment 100 includes one or more investor devices (e.g., smart phones, laptops) 102, one or more administrator devices (e.g., desktops computers) 104 and one or more servers 106, which may typically be remote from the investor devices 102. The devices 102, 104 and the servers 106 may communicate over one or more communication networks 108. A provider of an on-line banking app may use one or more servers 106 in communication with an administrator device 104 to install and/or configure an on-line banking app installed on an investor device 102. The devices 102, 104, servers 106 and communication networks 108 may be configured to communication with each other using various wired and wireless communication links. The investor devices 102, administrator devices 104 and servers 106 may be implemented, for example, using one or more of the environments 200 of FIG. 2.

FIG. 2 shows an embodiment of an environment 200 that may be employed to facilitate on-line banking services as described herein, such as by performing one or more methods disclosed herein. The environment 200 includes a computing system 10. For example, the computing system 10 may be configured as a user computing system, such as a computing system of an investor or depositor, a host server, such as a financial transactions server, a communications server, etc. The computing system 10 may, for example, be operated by a service providing on-line banking services and related goods and services to a consumer, by a consumer purchasing such goods or services from a service, by a vendor, such as a telecom service provider, an Internet service provider, etc. The computing system 10 may take the form of any of the variety of types discussed above, which may run a networking client, for example a server, a Web browser, etc. The computing system 10 comprises a processor unit or circuitry 12 (e.g., one or more processors or processing cores), a system memory 14 and a system bus 16 that couples various system components including the system memory 14 to the processing unit 12. The processing unit 12 may be any logical processing unit, such as one or more central processing units (CPUs), digital signal processors (DSPs), application-specific integrated circuits (ASIC), processing cores, etc., and various combinations thereof. Unless described otherwise, the construction and operation of the various blocks shown in FIG. 2 are of conventional design. As a result, such blocks need not be described in further detail herein, as they will be understood by those skilled in the relevant art.

The system bus 16 can employ any known bus structures or architectures, including a memory bus with memory controller, a peripheral bus, and/or a local bus. The system memory 14 includes read-only memory (“ROM”) 18 and random access memory (“RAM”) 20. A basic input/output system (“BIOS”) 22, which can form part of the ROM 18, contains basic routines that help transfer information between elements within the computing system 10, such as during startup.

The computing system 10 also includes one or more spinning media memories such as a hard disk drive 24 for reading from and writing to a hard disk 25, and an optical disk drive 26 and a magnetic disk drive 28 for reading from and writing to removable optical disks 30 and magnetic disks 32, respectively. The optical disk 30 can be a CD-ROM, while the magnetic disk 32 can be a magnetic floppy disk or diskette. The hard disk drive 24, optical disk drive 26 and magnetic disk drive 28 communicate with the processing unit 12 via the bus 16. The hard disk drive 24, optical disk drive 26 and magnetic disk drive 28 may include interfaces or controllers coupled between such drives and the bus 16, as is known by those skilled in the relevant art, for example via an IDE (Integrated Drive Electronics) interface. The drives 24, 26 and 28, and their associated computer-readable media, provide nonvolatile storage of computer-readable instructions, data structures, program modules and other data for the computing system 10. Although the depicted computing system 10 employs hard disk 25, optical disk 30 and magnetic disk 32, those skilled in the relevant art will appreciate that other types of spinning media memory computer-readable media may be employed, such as, digital video disks (DVD), Bernoulli cartridges, etc. Those skilled in the relevant art will also appreciate that other types of computer-readable media that can store data accessible by a computer may be employed, for example, non-spinning media memories such as magnetic cassettes, flash memory cards, RAMs, ROMs, solid-state drives, smart cards, etc.

Program modules can be stored in the system memory 14, such as an operating system 34 (for example, Windows™, Android™, etc.), one or more application programs 36, other programs or modules 38, and program data 40. The application programs 36 may include one or more application programs to facilitate providing on-line banking services disclosed herein, such as one or more application programs which when executed perform one or more of the methods disclosed herein. The system memory 14 also includes a server 41 for permitting the computing system 10 to exchange data with sources such as Web sites of the Internet, corporate intranets, or other networks, as well as other server applications on server computers. The server 41 may be markup language based, such as hypertext markup language (HTML), and operate with markup languages that use syntactically delimited characters added to the data of a document to represent the structure of the document, etc.

While shown in FIG. 2 as being stored in the system memory 14, the operating system 34, application programs 36, other program modules 38, program data 40 and server 41 can be stored on the hard disk 25 of the hard disk drive 24, the optical disk 30 and the optical disk drive 26 and/or the magnetic disk 32 of the magnetic disk drive 28. A user can enter commands and information to the computing system 10 through input devices such as a keypad or keyboard 42 and a pointing device such as a mouse 44. Other input devices can include a microphone, joystick, game pad, scanner, touch screen, card reader, chip reader, etc. These and other input devices as illustrated are connected to the processing unit 12 through an interface 46 such as a serial port interface that couples to the bus 16, although other interfaces such as a parallel port, a game port or a universal serial bus (USB) can be used. A display or monitor 48 or other display devices may be coupled to the bus 16 via video interface 50, such as a video adapter. The computing system 10 can include other output devices such as speakers, printers, etc.

The computing system 10 can operate in a networked environment using logical connections to one or more repositories 6 and/or other computing systems 8a-8n. The computer system 10 may employ any known means of communications, such as through a local area network (LAN) 52 or a wide area network (WAN), a telecommunications network or the Internet 54. Such networking environments are well known and may include, for example, any type of telecommunications network or other network, such as CDMA, OFDMA, GSM, WiMAX, VoIP, WiFi, Internet Protocol, various IEEE standard protocols, etc.

When used in a LAN networking environment, the computing system 10 may be coupled to the LAN 52 through an adapter or network interface 56 (communicatively linked to the bus 16). When used in a WAN networking environment, the computing system 10 often includes a device, such as a modem 57, a mobile phone communication module or other device for establishing communications over the WAN/Internet 54. As illustrated, a modem 57 is shown in FIG. 2 as communicatively linked between the interface 46 and the WAN/Internet/Telecommunications network 54. In a networked environment, program modules, application programs, or data, or portions thereof, can be stored in a server computer (for example, another configured computing system similar to the computing system 10). Those skilled in the relevant art will readily recognize that the network connections shown in FIG. 2 are only some examples of establishing communication links between computers and/or other systems and devices 60, and other links may be used, including wireless links. The devices may include, for example, cell phones, tablets, wireless devices, etc.

The computing system 10 may include one or more interfaces such as slot 58 to allow the addition of devices either internally or externally to the computing system 10. For example, suitable interfaces may include ISA (Industry Standard Architecture), IDE, PCI (Personal Computer Interface) and/or AGP (Advance Graphics Processor) slot connectors for option cards, serial and/or parallel ports, USB ports (Universal Serial Bus), audio input/output (I/O) and MIDI/joystick connectors, slots for memory, credit card readers, scanners, bar code readers, RFID readers, etc., collectively referenced as 60.

The term computer-readable medium as used herein refers to any medium that participates in providing instructions to processor unit 12 for execution. Such a medium may take many forms, including but not limited to, non-volatile media, and volatile media. Non-volatile media includes, for example, hard, optical or magnetic disks 25, 30, 32, respectively. Volatile media includes dynamic memory, such as system memory 14.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, as described hereinafter, or any other medium from which a computer can read.

Various forms of computer readable media may be involved in carrying one or more sequences of one or more instructions to processor unit 12 for execution. For example, the instructions may initially be carried on a magnetic disk of a remote computer. The remote computer can load the instructions into its dynamic memory and send the instructions over a telephone line using a modem. A modem 57 local to computer system 10 can receive the data on the telephone line and use an infrared transmitter to convert the data to an infrared signal. An infrared detector coupled to the system bus 16 can receive the data carried in the infrared signal and place the data on system bus 16. The system bus 16 carries the data to system memory 14, from which processor unit 12 retrieves and executes the instructions. The instructions received by system memory 14 may optionally be stored on storage device either before or after execution by processor unit 12.

The repository 6 is a permanent storage medium for data. The repository 6 may be specific to each end user, or shared between some or all end users. For example, different services vendors or concerned parties (for example, family members or health care providers) may have separate repositories or may share repositories. The repository 6 (only one illustrated) may run on the same computing system as an application accessing the repository, or on another computing system accessible over the network 52, 54.

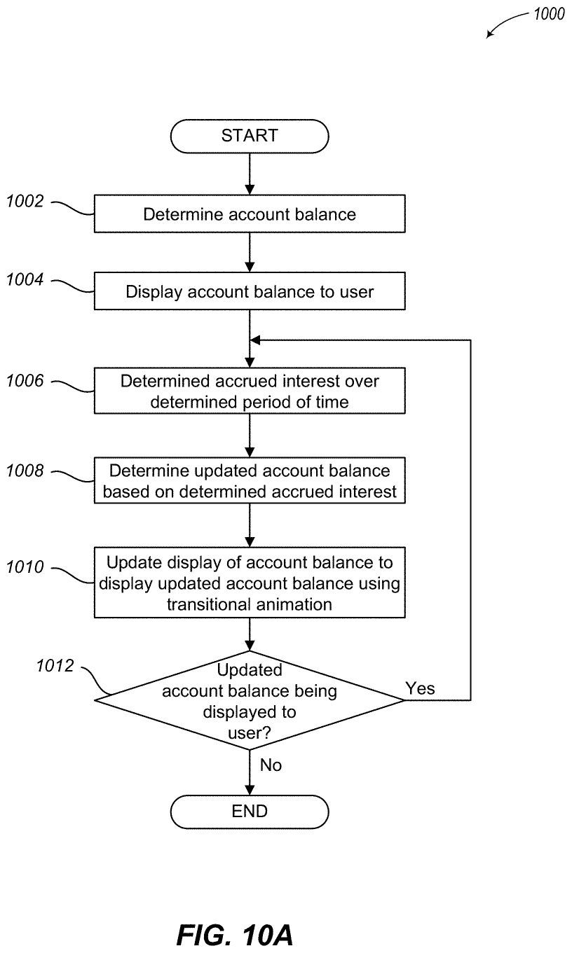

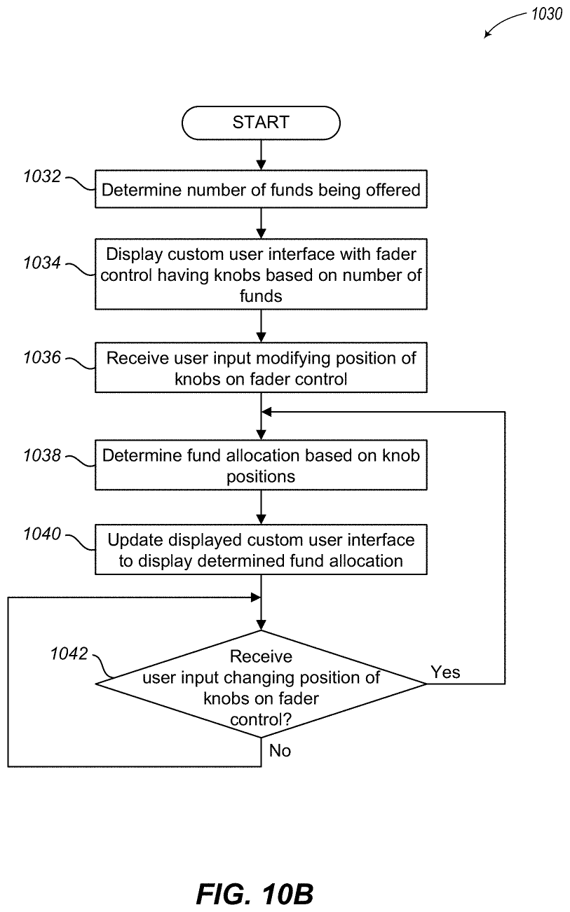

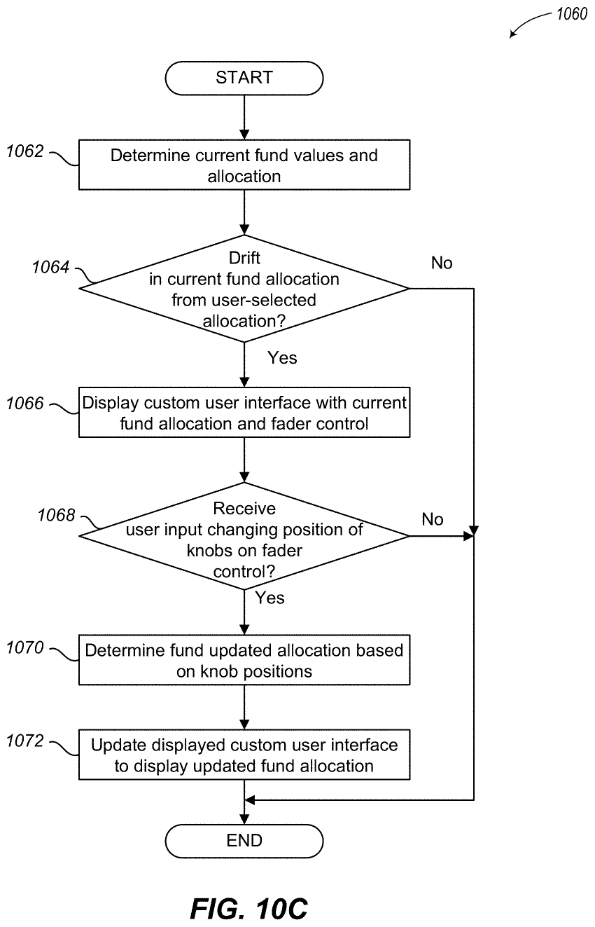

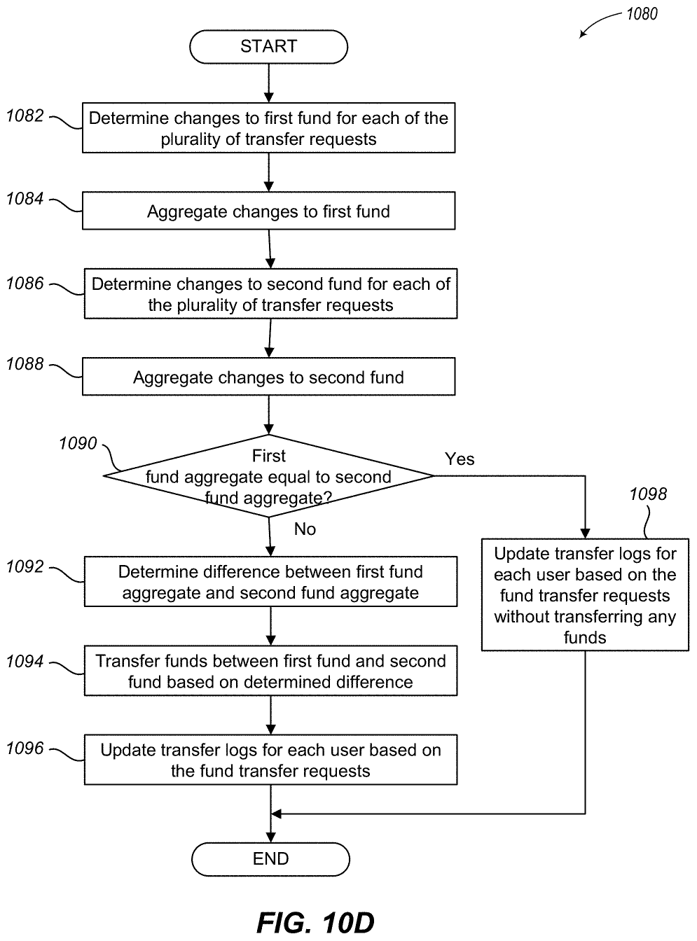

Embodiments of the computing system 10 of FIG. 2 may not include all of the illustrated components of the computing system 10, may contain additional components not shown in FIG. 10, and may not be configured as shown in FIG. 10. For example, a computing system 10 configured as customer system may not include an optical disk drive and may include an application specific integrated circuit or a digital signal processor (not shown) to perform one or more of the functions of the customer system. In another example, a detector or transceiver may include one or more telecommunications modules to handle call processing, such as CDMA, OFDMA, GSM, etc., call processing.

### Disclosed Embodiments of On-Line Banking Services

With a traditional deposit account, interest is calculated and compounded every 12 months, 6 months, 3 months, 1 month or on daily basis (frequency determined by the financial institution providing the account). Compounded refers to the interest being credited to the account, so the interest itself will begin to also generate interest.

As the interval between compounding shortens, so the APY (Annual Percentage Yield) increases for a given (fixed) APR (Annual Percentage Rate) value. For example if the APR is 2.0%, and the compounding period is 12 months, then the APY will also be 2.0%, but however if the compounding period is shortened to 1 month then the APY rises to 2.018%. In brief, a shorter compounding period means a higher APY and therefore a greater increase in the account value for the depositor.

The depositor typically is informed of the interest that has been accrued on a periodic basis, either through a paper statement or in their online account. This period either matches the compounding period, or is a multiple thereof. For example, some banks may choose to compound monthly but only report the interest and deposit it into the account every 6 months. The longer a period is, the less favorable the conditions are for the depositor.

In an embodiment, both the compounding period and reporting period can be shortened so it may be considered by the depositor to be a method of continuous interest generation, compounding and reporting.

In an embodiment, the compounding and reporting is based on an approximation of “continuous”, using a small interval between compounds (e.g., 1 second) and a series of transitions on a real-time display that imply continuous updates. In an embodiment, the depositor in any moment may see, with high precision, the level of interest generated on their account, and avoiding a feeling of delay between when interest is credited to the depositor (as there would be in the case of a traditional reporting period).

### Visualizing Continuous Interest

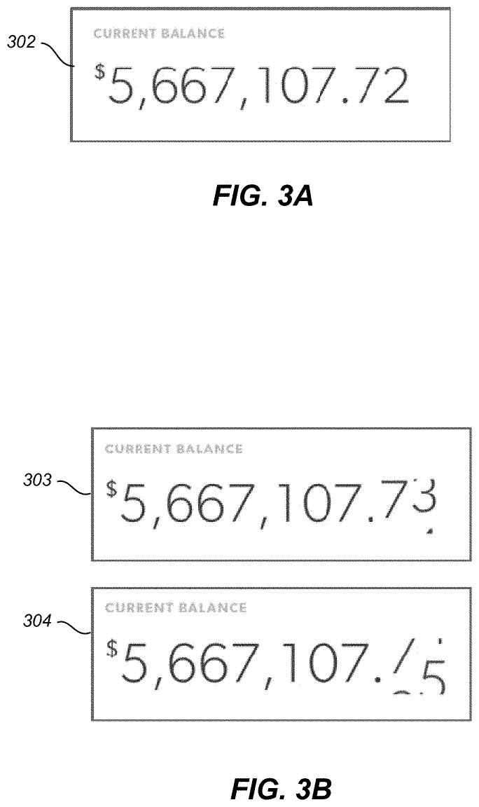

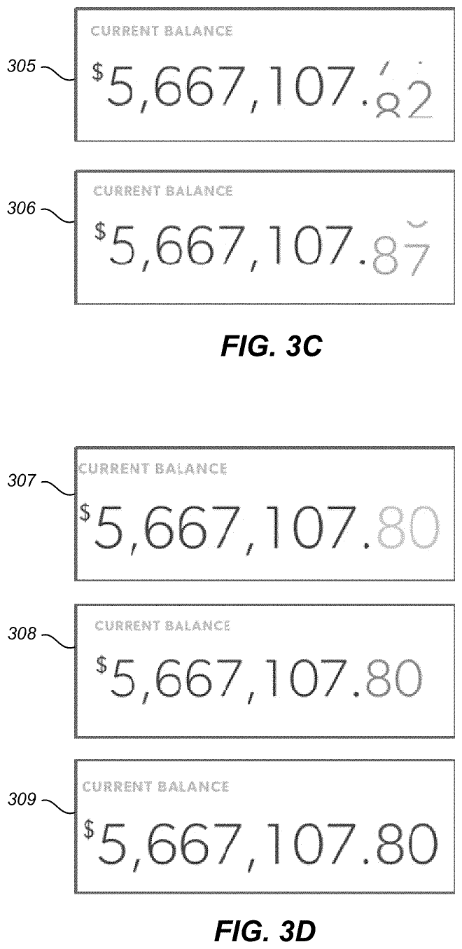

In an embodiment of visualizing continuous interest generation, a near real-time view of the balance is displayed (e.g., on a display of a computing device), with a transitional animation between each balance update, as illustrated, for example, in FIGS. 3A-3D.

FIG. 3A illustrates display 302 of a current near real-time balance of an account, including a precise (to a desired degree) calculation of the interest generated to the nearest couple of seconds.

FIG. 3B illustrates display 303 and 304. Display 303 starts the transitional animation, with both the unit cents and tens cents digits starting to spin upwards. Display 304 shows a continuation of the transitional animation as the balance is updated. As described herein, the least significant digit (unit cents) transitions, which in this case rotates, at a faster rate than the more significant digit (tens cents) that is also being updated.

FIG. 3C illustrate display 305 and display 306, where the color of the changing digits fades to a highlight or different color to indicate positive change. In this illustrated example, the unit cents and tens cents digits are being updated. Display 305 shows these digits as transitioning from black to a first shade of gray and display 306 shows these digits as transitioning from the first shade of gray to a second shade of gray, where the second shade of gray is lighter than the first shade of gray. The resulting shade of gray, when at the updated balance, may be an even lighter shade of gray. Although shown as different shades of gray, the changing digits may be other colors, such as green.

FIG. 3D illustrates displays 307-309, where the balance comes to rest on the new value and the highlight color (e.g., gray) fades back to the static color (e.g., black).

In an embodiment, the animation pauses for a short period (e.g., 1 second) to allow the depositor to comfortably read the amount, and then the animation starts again, increasing the balance by the interest generated over the next period of one second (or a few seconds).

In one embodiment, the least significant digits are rotated faster than the more significant digits that also undergo a change in this update. If the least significant digit(s) in practice do not need much movement in this update (e.g., where the affected digits are the last two digits moving from “72” to “83”), then the animation does a full rotation of the least significant digit. This exaggerated movement is used to emphasize the increase.

Visualizing Balance Updates that Increase the Order of Magnitude

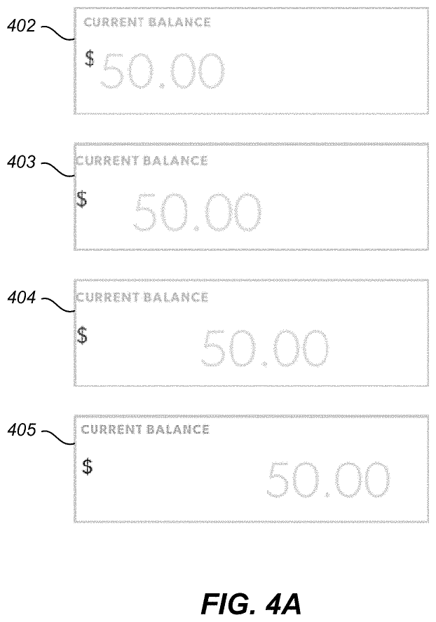

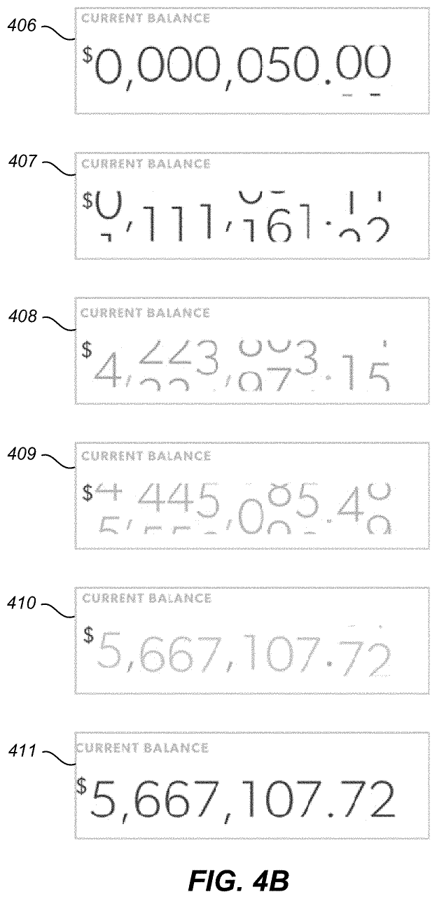

In an embodiment, if a stepped increase in the balance should occur (e.g., because the depositor has made an additional deposit to their account), then the transition animation also incorporates the step increase, plus the generated interest. In a variation, if an increase should occur that causes an increase in the number of digits required to display the balance, then a special transition is used to show this change. An example of this is shown in FIGS. 4A-4B.

As illustrated, the balance is shown increasing in a single transition animation cycle from a low value (initial balance) to a high value (updated balance). The initial amount first slides to the right to make room for the larger balance, right aligning itself with the new balance, which is shown by displays 402-405 in FIG. 4A. Leading zeros are added to pad the full number space for the updated balance, which is illustrated by display 406 in FIG. 4B. Then the rotation animation starts, this time with all digits transitioning until the new balance is shown, as illustrated by displays 407-411 in FIG. 4B—similar to what is illustrated in FIG. 3B. In this illustration, the updating digits also transition from black to gray indicating the increase, and then back to black once stable—similar to what is illustrated in FIGS. 3C-3D.

### Visualizing Smaller Changes

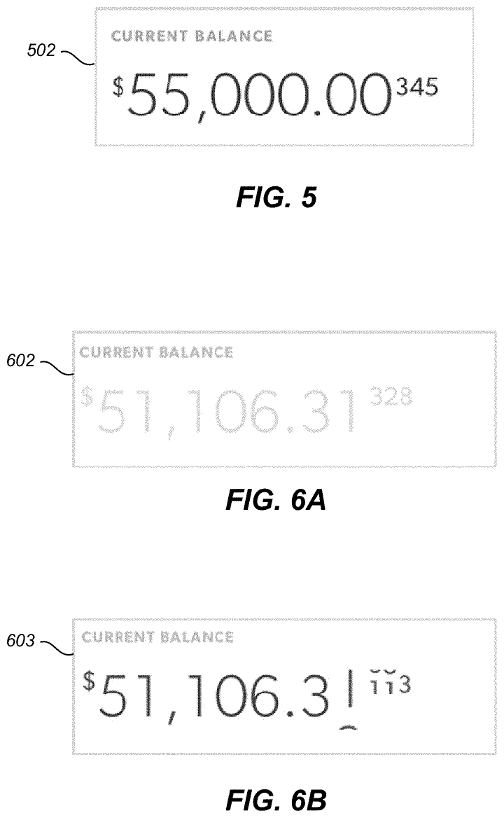

In the examples provided above, the balance is large enough that the interest generated every second (or determined time period) results in an increase of a few cents. Therefore, this can easily be visualized using the unit cents and tens cents digits. However, for smaller amounts, the difference between updates may be smaller than one cent. In order to show continuous growth at this scale, FIG. 5 shows an embodiment of a display 502 showing the balance including micro-cents. When the interest amount is less than one cent, the micro-cents digits may be displayed with the balance. In this way, an interest amount of less than one cent is shown by transitioning the micro-cents using one of the transition methods described herein. In an embodiment, most of the transitional animation activity takes place on the micro-cent range of digits.

When it is detected that the interest generated with every update is sufficient to see an increase in the unit cents, then the micro-cents may be automatically switched off.

### Off-Ledger Interest Generation

A technical downside of reducing the compound and presentation period to such a small value is that it becomes too resource intensive to update a ledger system with every update.

Consider that the ledger of a typical savings account contains less than 5 entries per month, whereas in an embodiment described here where the interest is generated every 1 second the storage requirements for that ledger would increase to 2,592,000 entries per month if each event was to be stored.

Therefore in an embodiment ledger entries are created for the interest at the end of each month and when there is another event that impacts the balance (such as a deposit or withdrawal). To facilitate illustrating the near real-time balance, a calculation may be made that effectively generates the additional interest without storing it to the ledger.

In an embodiment, this calculation is:

$$Display balance = {B ( 1 + \frac{r}{n} )}^{nt}$$

where:

‘B’ is the most recent stored balance in the ledger;

‘r’ is the APR;

‘n’ is the number of times we compound the interest per year, e.g., if per second compounding then this figure is 31,536,000; and

‘t’ is the amount of time in years that has passed since the timestamp of the stored balance (e.g., if 100,000 seconds have passed then t is the fraction 100000/31536000).

Additionally, in an embodiment where the balance is being viewed by the depositor from a web browser, or by an application (e.g., on a mobile device), then the resource requirements of calculating the display balance may be distributed to the edge (e.g., the local device of the depositor makes the calculation rather than the network server where the ledger is held). Therefore, in an embodiment, the local device would connect to the server and request the values of B, r, n, and the timestamp of when B was updated. The local device would then locally calculate t based on the difference between the present time and the provided timestamp.

In a variation of the above approach, the server provides B, r, and n, except instead of B being the last stored balance, it is actually the current balance in the moment it is requested (calculated by the server using the same formula as above). The local device starts the timer from the moment it receives the server response and, thus, the local calculation is based on a relative value oft measured from the last timestamp the server provided B.

Furthermore, these calculations may be performed when a visual presentation of the balance is being displayed to a user; no calculation is necessary if the balance is not being shown on the local device.

Transitioning from an Out-of-Date Balance to a New Balance

In an embodiment, when the application that displays the balance is loaded on a local device, it can most quickly retrieve the previously displayed balance (which can be stored locally) before it has chance to send a request to the server and receive the response containing the updated balance (or information from which the local device may determine the updated balance).

Therefore to facilitate the depositor understanding how their balance has changed since the depositor last checked on it, the update balance may be generated and displayed as shown in FIGS. 6A-6B. For example, display 602 in FIG. 6A shows an out-of-date balance being displayed in greyed-out text. In an embodiment, this balance may be out of date because it is obtained from local storage, rather than from the banking server. In contrast, display 603 in FIG. 6B shows an updated balance being retrieved from the banking server or calculated based on information retrieved from the server, and the out-of-date balance rotates to the current balance and fades in to view.

### Variations of Visualizing Continuous Interest Generation According to Various Embodiments

In one variation, instead of pausing between each animation cycle for one second, the transition between balance values is constant.

In another variation, a countdown between interest generation events is visualized or displayed. In an embodiment, the countdown may be the same as the determined period in which accrued interest is determined. In another embodiment, the countdown may be longer than the determined period of interest accrual, and the interest may be accrued and compounded multiple times during the countdown.

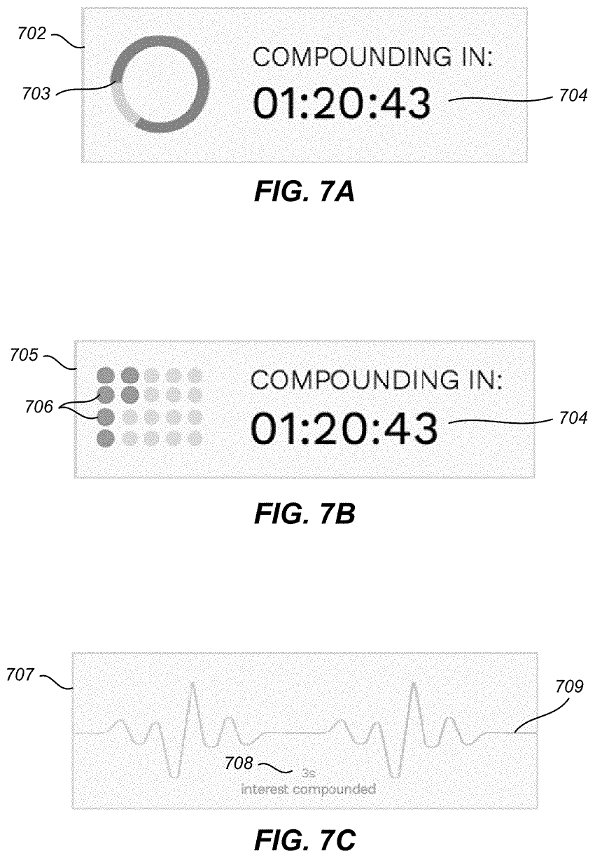

One such approach of a countdown is illustrated in FIG. 7A, which shows a display 702 illustrating a circle 703 that fills from light to dark along the circumference, while a countdown timer 704 falls towards zero. When the circle 703 is fully dark, and the timer 704 reaches zero (the timer 704 reaches zero as the circle 703 becomes fully dark), the interest event occurs and the balance is updated. The animation then repeats.

A variation of a countdown display is shown in FIG. 7B, which is similar to what is shown in FIG. 7A, but instead of a circle, display 705 includes a matrix of dots 706 that fill from light to dark, one dot at a time, top-to-bottom, left-to-right (other sequences of dots filling may also be employed). When all the dots 706 are dark and the timer 704 reaches zero (the timer 704 reaches zero as the last dot 706 becomes dark), the interest event occurs and the balance is updated. The animation then repeats.

Another variation of a countdown display is shown in FIG. 7C. In this example, a display 707 includes countdown timer 708 that falls towards zero. At the same time a sinewave 709 pattern is displayed. When the timer 708 reaches zero, a spiked pattern appears on the sinewave meter 709 and the balance is updated. The animation then repeats.

Interest Generation from the Point of Deposit Initiation

In a traditional deposit account, when a deposit is made the balance is updated at the point the deposit is received by the financial institution. Due to the non real-time nature of moving funds between bank accounts (and between institutions) there may be a delay of up to a few days between the moment the account holder initiated the transfer of funds and the point at which these funds show in the destination deposit account. During this period the account holder will not only be unable to see the balance reflected in their deposit account, but furthermore they will not be accruing interest during this time. In an embodiment, an online mechanism is provided where a remote account (funding source) can be linked to the target deposit account and authorization given by the depositor to allow the system to send a transfer request to the remote financial institution on behalf of the depositor.

Because the transfer is initiated from the receiving end, it may be immediately reflected in the balance of the target account (since the intent to transfer is identified and the dollar value of the transfer are known). It is also possible to start accruing interest from this moment (per the continuous interest mechanism described earlier).

### Rollback of Transfer

In an embodiment, the system monitors the status of the transfer and should it subsequently fail, then a correction is made to the account's balance and the depositor is informed of the change.

In an embodiment, on notification of the failure of the transfer, the system performs the following actions:
1. The ledger entry for the deposit is marked as FAILED;
2. The before and after balance of each subsequent entry in the ledger is recalculated;
3. The current balance is reduced, removing both the value of the failed deposit and the value of any interest accrued from the deposit (while leaving intact any interest accrued in the same period from other deposits that have not failed);
4. The balance displayed to the depositor is refreshed to reflect the change, which may be done by a transitional animation described herein (which may include a different highlight color, such as red, to indicate the negative change);
5. An activity summary/statement presented to the depositor shows a reversal of the balance proceeds due to the failed deposit; and
6. If the activity summary/statement previously stated interest earned that either itemized the interest accruing from the same deposit, or included the interest from the deposit in some broader interest summary, then a new entry in the activity summary would show a reversal of the interest payment.

### Simplified Mechanism to Rebalance a Portfolio of Funds

Existing self-service web and mobile tools allow an investor to manage how their money is invested when there is an offering of multiple funds (or investment instruments). Depending on the tool being used, this can be realized in different ways, including:
1. Self determining a specific dollar amount to be assigned to a given fund, or the number of units desired in that fund and usually requiring an explicit order approval before proceeding with the purchase;
2. Answering risk (or other investment preference) related questions which are then used to algorithmically determine how a given balance of money should be split between two or more funds; and
3. Directly entering percentages to define the ratio used to split cash between each fund and then determining the dollar amounts that should be allocated across them.

Each of these methods includes a reasonable amount of set-up by the investor in order to function according to investor preferences.

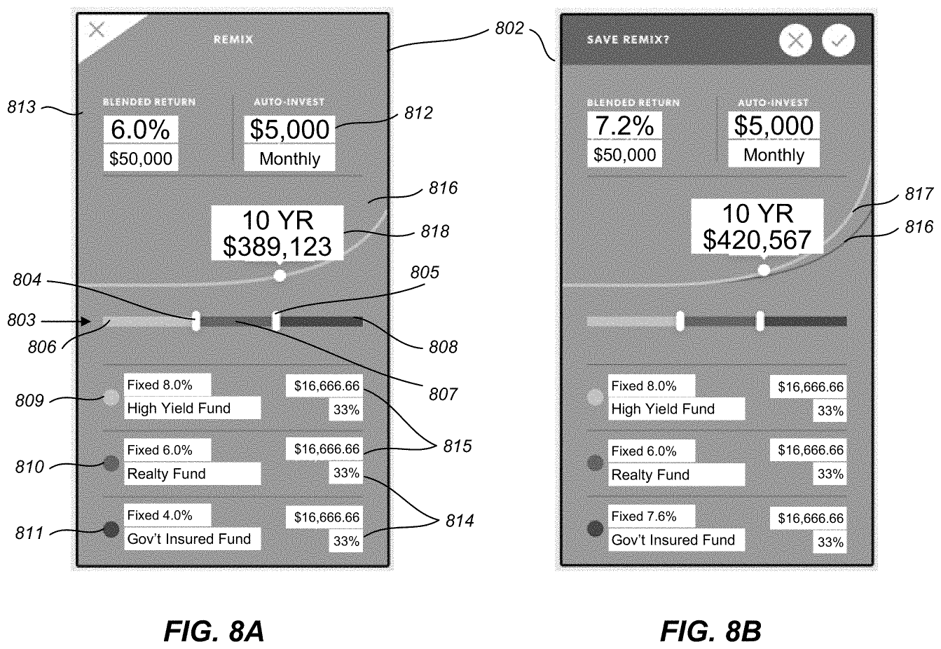

An alternative mechanism by which the investor can determine how their money is allocated to two or more funds may be provided, which is shown in FIGS. 8A-8B. In an embodiment, a custom UI (user interface) 802 includes a fader control 803 that resembles a single volume control fader but has the distinction of having more than one knob or slider. The quantity of knobs is equal to one less than the number of funds being offered. The full length of the fader control 803 represents 100% of either the existing balance, or new deposit. In the example shown in FIG. 8A, there are 3 funds represented on the fader: High Yield Fund 809, Realty Fund 810, and Gov't Insured Fund 811.

Each of the two knobs 804 and 805 can be dragged to the left or right, or in opposite directions. Changing the position of the knobs 805 or 805 sets the investor's preference as to how their money is allocated between the funds.

In the example shown here, dragging both knobs 804 and 805 fully to the right would assign 100% of the balance to the High Yield Fund 809, which would include control portion 806 accounting for 100% of the fader control 803 and control portions 807 and 808 accounting for 0% of the fader control 803 (not illustrated). Dragging both knobs 804 and 805 fully to the left would assign 100% of the balance to the Gov't Insured Fund 811, which would include control portion 808 accounting for 100% of the fader control 803 and control portions 806 and 807 accounting for 0% of the fader control 803 (not illustrated). Dragging the left-hand knob 804 fully to the left and the right-hand knob 805 fully to the right would assign 100% to the Realty Fund 810, which would include control portion 807 accounting for 100% of the fader control 803 and control portions 806 and 808 accounting for 0% of the fader control 803 (not illustrated). Besides these three extreme cases, positioning the knobs 804 and 805 at various points across the length of the fader control 803 would determine a ratio by which the balance would be split between the three funds, which is illustrated by control portions 806-808.

The custom UI 802 may also display an automatic investment amount 812 and a blended return 813. The automatic investment amount 812 is an amount selected by the user to be automatically invested in funds 809-811 based on the allocation selected with fader control 803. The blended return 813 is an overall interest rate of the account at an aggregate level among funds 809-811.

While the investor is dragging the knob(s) 804 or 805 a number of things may be happening:
1. The percentage 814 of balance that is allocated to each of the funds 809-811 is updated substantially instantly on the custom UI 802.
2. The dollar amount 815 allocated to each fund 809-811 is recalculated and updated substantially instantly on the custom UI 802.
3. The forecast of future portfolio value (sum of all funds) is recalculated and updated substantially instantly in the form of a chart 816 (value over time).
4. In an additional feature of the forecast chart of an embodiment, the forecast based on the currently saved configuration is shown as one series on the chart 816, with the newly adjusted fund allocation preferences used to plot a second series 817, which is shown in FIG. 8B. This is done such that the investor can see the impact of the changes they have made.
5. In a further feature of the forecast chart of an embodiment, one or more points 818 on the chart 816 are highlighted and the dollar value of that point is displayed. The investor may tap other points on the chart in order to see a readout of the dollar value of that particular point.
6. The blended return 813 (or portfolio annual interest rate) updates instantly as the knob is dragged showing how the increase or decrease of the ratio between funds affects the overall interest rate of the account at an aggregate level (since each individual fund may have a different individual interest rate).
7. A “SAVE?” prompt appears such that the investor may choose to commit the changes they are making. An investor may ignore this request and continue to try different configurations before committing to one.

When the new configuration is committed (by tapping the SAVE confirmation button), the existing balance held by the investor is reallocated between the funds according to their new preference, and future deposits are also shared between the funds based on the same ratio.

### Simplified Mechanism to Normalize a Portfolio of Funds

When a portfolio of funds is configured according to a ratio (e.g., x % of the portfolio in fund X, y % in fund Y), the ratio may drift from the original values over time if the funds do not all accrue interest at the same rate. This is simply because one fund is growing faster than another, and so the fastest growing fund tends to overpower the others.

In an embodiment, when the effect of this “drift” from the original value has reached a threshold level (e.g., a level considered significant, such as the portfolio percentage allocation rounded to the nearest whole number no longer matches the original investor-determined values), then the investor may be prompted to take action.

That choice of action includes:
1. KEEP IT AS IS: accept the new ratio based on the actual balance of the funds. When choosing this option, the configuration is updated to match the new ratio of balances. No money is moved between the funds. New deposits are automatically split between the funds according to the newly adjusted ratio.
2. REVERT: keep the previously saved configuration. A calculation is made to determine what the dollar value of each fund's balance should be based on the saved configuration, and compared with the actual balance currently held in each fund. The money is then transferred between the funds to bring the ratio in-line with the saved configuration. In an embodiment, the funds may remain the same, without a transfer from one fund to another, but new deposits are allocated among the funds such that the resulting balance of each fund is at or closer to the saved configuration, which allows for the new deposits to be allocated differently over time such that the allocation of total balances of the fund matches the saved configuration.

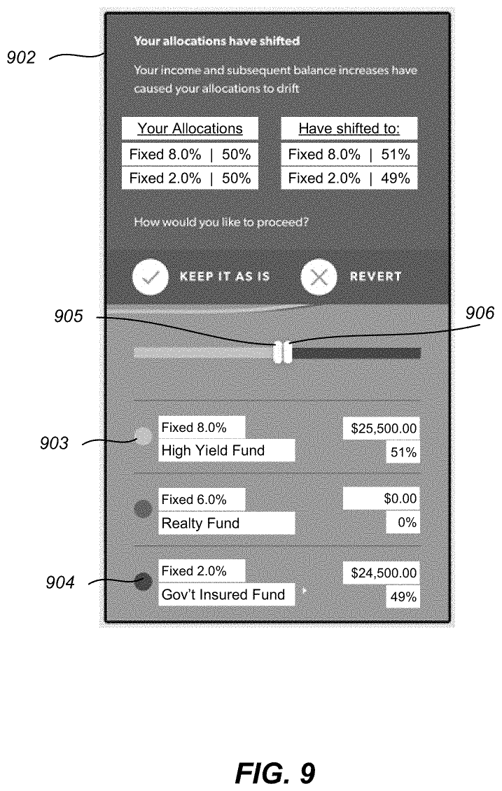

FIG. 9 is an example display 902 of a prompt after the drift threshold is reached. In an embodiment, the threshold may be adjustable by a depositor or a system administrator, the threshold may be a percentage (e.g., of the total amount), multiple thresholds may be used (e.g., time and drift thresholds), etc., and various combinations thereof. In this illustration, the original allocation is 50% High Yield Fund 903 and 50% Gov't Insured Fund 904, but have shifted to 51% High Yield Fund 903 and 49% Gov't Insured Fund 904. The user can adjust one or more of knobs 905 or 906 to reallocate the funds.

### Consolidating Internal Fund Transfers

When a deposit is made into a portfolio account, there is first an external transfer (a movement of money from the investor's external bank account into the portfolio account), followed by one or more internal transfers in which the money is allocated to the bank account of the fund(s) that the investor has chosen to invest in.

Ideally the fewest number of transfers takes place as possible, in order to reduce errors and cost (assuming each transfer incurs some kind of transfer fee).

In an embodiment, internal transfers of one or more investors are consolidated to reduce the number of transfers (e.g., to a smallest number of transfers possible).

As a feature of consolidation, if two investors were to make portfolio configuration changes in the same time window, of equal and opposite effect then this would have a sum total of zero impact on the consolidated transfer. For example, if Member A was to move $100,000 from High Yield Fund to Realty Fund, on the same day that Member B was to move $100,000 from Realty Fund to High Yield Fund, then no transfer takes place. Hence in this specific example, two internal transfers in fact get reduced to zero internal transfers.

This example just described two discrete portfolio configuration changes. However the consolidation exercise extends beyond portfolio configuration changes to also include deposits and withdrawals.

Consider the set of investor activities listed in Table 1, which occur within the same time window:

TABLE 1
Investor Activities

| | Impact on | Impact on |
|---|---|---|
| Event | FUND-A | FUND-B |
| Investor-A deposits $5,000 | +$5,000.00 | — |
| (100% to FUND-A) | | |
| Investor-B deposits $50,000 | +$25,000.00 | +$25,000.00 |
| (50% to FUND-A and 50% to FUND-B) | | |
| Investor-C adjusts portfolio configuration | −$50,000.00 | +$50,000.00 |
| ($100,000 balance with 100% in FUND-A, | | |
| adjusted to 50/50) | | |
| Investor-D withdraws $20,000 | — | −$20,000.00 |
| (100% held in FUND-B) | | |
| Investor-E withdraws $5,000 | −$4,000.00 | −$1,000.00 |
| (80% held in FUND-A, 20% held in | | |
| FUND-B) | | |
| | −$24,000.00 | +$54,000.00 |

Executed discreetly, these actions would generate 8 separate internal transfers. In an embodiment, consolidation reduces the number of internal transfers to just 2 transfers. Here is how:
1. An intermediate management account is used.
2. All external transfers are sent in and out of the intermediate management account.
3. A consolidation table is built (as given in the example above) by creating entries under each fund that are positive for an incoming amount to that fund, and negative for any outgoing amount from the fund.
4. Each column is totaled, giving the net impact of the actions on each fund.
5. For each negative total column, a transfer is initiated to send that amount from the fund to the management account.
6. For each positive total column, a transfer is initiated to send that amount from the management account to the fund.
7. The following order is preserved: (1st) external deposits (money arriving to the management account), (2nd) negative internal movements, (3rd) positive movements, (4th) external withdrawals. This order facilitates funds being made available in the management account before funds are moved into the net benefiting funds, or to external accounts.
8. So in the example shown above, after receiving the external deposits, a transfer of $24,000 is created from FUND-A to the management account. Then a transfer of $54,000 is created from the management fund to FUND-B. The two withdrawal requests are then processed, taking the full amount from the management fund.

Although this illustrated example includes five investors and two funds, other numbers of investors and funds may also be employed, so long as there is at least some overlap in the funds for the investors.

### Increasing the APR Based on Conditions

A typical fund either has a fixed or a variable rate of interest. In the variable case the APR is linked to the performance of the underlying financial instrument(s). In the fixed case the APR is pre-determined either by the financial institution offering the fund, a regulator, or some other entity.

In an embodiment, a fixed rate fund may be modified to have periods of variability based on certain conditions. The way this is envisaged to be used is to give the investor bursts of positive performance in their account while a condition is active.

Using similar techniques to those described earlier, this burst of increased performance can be visualized for the investor by seeing the transitional animations of the balance speed-up, demonstrating a greater rate of wealth generation during this period (e.g., double interest).

Addressed below are possible conditions that may be used to trigger bursts of increased performance.

### 1. Location Based Conditioning

In one scenario the investor is given a higher interest rate while present in a particular location. This might be further restricted by being a particular location only on a particular day and time, e.g., this incentive could be linked to the investor attending a specific event.

### 2. Special Days

In another scenario, an investor is given a higher interest rate on particular days (or other periods). This could be universally applicable offers to all investors, such as double interest on New Years Eve, or it could be personalized to the member, such as their birthday or their anniversary.

### 3. Achievements

In a further scenario, an investor is awarded a period of increased interest if the investor has reached a certain achievement level. This could, for example, be when the investor has invested a certain amount of dollars either one-off or over a period of time. Or it could be if the investor has earned a certain level of interest, has invited other investors to sign-up, etc., and various combinations thereof.

The achievements could be individual to the investor of they could be based on investor community wide goals (e.g., if more than 1,000 new investors are invited to join the service this week then everyone gets double interest for 24 hours).

The period of reward could be anything from a short burst (e.g., 1 minute) or a longer period, or endless (e.g., a permanent increase in the interest rate based on reaching a given status).

The operation of certain aspects of the disclosure will now be described with respect to FIGS. 10A-10D. In at least one of various embodiments, processes 1000, 1030, 1060, and 1080 described in conjunction with FIGS. 10A-10D, respectively, may be implemented by one or more computing devices, such as devices 102, 104 and servers 106, to perform actions and embodiments as described herein.

FIG. 10A illustrates a logical flow diagram generally showing an embodiment of a process 1000 for displaying continuous interest generation. Process 1000 begins, after a start block, at block 1002, where an account balance is determined. In various embodiments, a user may first log into an account profile and select a desired account. The account balance for the selected account may be obtained from a server or databased that maintains account balances.

Process 1000 proceeds to block 1004, where the account balance is displayed to the user. In an embodiment, the account balance is displayed in a graphical user interface that is enabled to perform transitional animations, as described herein. In an embodiment, where process 1000 is performed by a bank server (e.g., server 106), display of the account balance may include providing the account balance to a user computer (e.g., devices 102, 104) for display or presented via a web-based interface.

Process 1000 continues at block 1006, where an accrued interest is determined over a period of time. The period of time may be, for example, less than one second but greater than zero. The period of time may also be greater than one second in some embodiments. In an embodiment, the period of time is less than a display time period. The display time period is a time in which the account balance is being displayed to the user.

Process 1000 proceeds next to block 1008, where an updated account balance is determined based on the determined accrued interest. In an embodiment, the determined accrued interest is added to the current account balance to equal the updated account balance.

Process 1000 continues next at block 1010, where the displayed account balance is updated to the updated account balance using a transitional animation, as described herein. For example, the digits in the account balance that change may be rotated to an updated value as discussed above in conjunction with FIGS. 3A-3D, 4A-4B, 5, or 6A-6B.

Process 1000 proceeds to decision block 1012, where a determination is made whether the updated account balance is still being displayed to the user. If the updated account balance is still being displayed to the user (e.g., the user has not changed screens or performed actions to halt display of the account balance), process 1000 loops to block 1006 to determine a next accrued interest over the determined period of time. By looping while the updated account balance is still being displayed to the user, the next accrued interest and next updated account balance can be determined and displayed to the user, which provides a near real-time display of the account balance for near real-time interest accrual and compounding. If the updated account balance is no longer being displayed to the user, process 1000 terminates or otherwise returns to a calling process to perform further actions. In an embodiment, the system continues to calculate the accrued interest at the determined period of time, but not at a near real-time rate for display.

FIG. 10B illustrates a logical flow diagram generally showing an embodiment of a process 1030 for enabling a user to dynamically allocate an investment among multiple funds. Process 1030 begins, after a start block, at block 1032, where a number of funds being offered to a user are determined. The number of funds may be set by an administrator, financial advisor, the user.

Process 1030 proceeds to block 1034, where a custom user interface is displayed to the user. The custom user interface includes a fader control having knobs, as illustrated in FIGS. 8A-8B and 9. The number of knobs is one less than the determined number of funds being offered. In this way, the portion of the fader control between adjacent knobs, or between a knob and an adjacent end of the fader control, represents the percent allocation for a given fund.

Process 1030 continues at block 1036, where user input modifying a position of one or more knobs on the fader control is received. As discussed herein, the user can move one or more knobs left or right to adjust the percent allocation for each fund being offered.

Process 1030 proceeds next to block 1038, where the fund allocation for each fund is determined based on the knob positions. In an embodiment, the fader control may include 100 positions, where each position or the distance between each position is based on a total number of pixels used to display the fader control—e.g., the total number of pixels is divided by 100 resulting in the pixel distance between knob positions. The difference between knob position values for adjacent knobs, or between a knob and an adjacent end of the fader control, may be used to determine the percent allocation for the fund associated with the portion of the fader control between the knobs. For example, if knob one is at position 34 and knob two is at position 98, then a first fund may be 34% (position 34 minus position 0), a second fund may be 64% (position 98 minus position 34), and a third fund may be 2% (position 100 minus position 98).

In an embodiment, a total investment amount or automatic deposit amount is allocated or divided up between the funds based on the percent allocations determined by the knob positions on the fader control.

Process 1030 continues next at block 1040, where the displayed custom user interface is updated to display the determined fund allocation. The custom user interface may be updated to include the allocation percentages and the respective investment amount for each fund.

Process 1030 proceeds to decision block 1042, where a determination is made whether additional user input is received, which changes the position of one or more knobs on the fader control. If the user has modified the position of at least one knob, then process 1030 loops to block 1038 to determine updated fund allocations based on the new positions of the knobs; otherwise, process 1030 loops to decision block 1042 to wait for the user to change the position of at least one knob on the fader control. By looping while the user is modifying the position of at least one knob, the user is provided with a dynamically changing allocation for each fund based on the knob positions.

FIG. 10C illustrates a logical flow diagram generally showing an embodiment of a process 1060 for enabling a user to view fund allocation shifting. Process 1060 begins, after a start block, at block 1062, where current fund values and allocations are determined. In some embodiments, the fund values are obtained from a database. The fund values are then added together and divided by the number of funds to determine the allocation of each fund with respect to the total value.

Process 1060 proceeds to decision block 1064, where a determination is made whether the current fund allocation has drifted from the user-selected allocation. In an embodiment, the current fund allocation for each respective fund is compared to the user-selected allocation for each respective fund. If there are any differences between the current fund allocations and the user-selected allocations, then process 1060 flows to block 1066; otherwise, process 1060 terminates or otherwise returns to a calling process to perform further actions.

At block 1066, a custom user interface is display to the user with the current fund allocation and a fader control, similar to the display of the fader control at block 1034 in FIG. 10B. The position of each knob on the fader control is based on the current fund allocation for each fund. In an embodiment, the custom user interface may also display the previously selected fund allocations in numerical percentages. Alternatively, the fader control may include “frozen” knobs illustrating the previous position of the knobs for the previously selected allocations.

Process 1060 proceeds next to decision block 1068, where a determination is made whether additional user input is received, which changes the position of one or more knobs on the fader control or accepts the current fund allocation. If the user has modified the position of at least one knob, then process 1060 continues to block 1070; otherwise, process 1030 terminates or otherwise returns to a calling process to perform other actions.

At block 1070, updated fund allocations are determined based on the changed knob positions. In an embodiment, block 1070 may employ embodiments, of block 1038 in FIG. 10C to determine the updated fund allocations.

Process 1060 continues next at block 1072, where the custom user interface is updated to display the updated fund allocation. In an embodiment, block 1072 may employ embodiments, of block 1040 in FIG. 10C to display the updated fund allocations.

After block 1072, process 1060 terminates or otherwise returns to a calling process to perform other actions.

FIG. 10D illustrates a logical flow diagram generally showing an embodiment of a process 1080 for providing reduced fund transfers among multiple users. Process 1080 begins, after a start block, at block 1082, where changes to a first fund for each of a plurality of transfer requests are determined. In an embodiment, the plurality of transfer requests may be from one or more users.

Process 1080 proceeds to block 1084, where the changes to the first fund are aggregated. In various embodiments, the deposits to the first fund from the plurality of transfer requests are added together as a subtotal and the withdrawals to the first fund from the plurality of transfer requests are subtracted from the subtotal resulting in a total change to the first fund.

Process 1080 continues at block 1086, where changes to a second fund for each of the plurality of transfer requests are determined. The plurality of transfer requests may be the same or include at least a portion of the same transfer requests associated with the first fund described in block 1082.

Process 1080 proceeds next to block 1088, where the changes to the second fund are aggregated. In various embodiments, the deposits to the second fund from the plurality of transfer requests are added together as a subtotal and the withdrawals to the second fund from the plurality of transfer requests are subtracted from the subtotal resulting in a total change to the second fund.

Process 1080 continues next to decision block 1090, where a determination is made whether the first fund aggregate is equal to the second fund aggregate. If the first and second fund aggregates are equal, then process 1080 flows to block 1098; otherwise, process 1080 flows to block 1092.

At block 1098, transfer logs for each user associated with the plurality of transfer requests are updated based on the plurality of fund transfer requests without transferring any funds between the first and second funds. In this way, the transfer logs indicate that money has changed from one fund to another for each particular transfer request, but no money has actually changed funds because the resulting change would have been zero, which can reduce payment of transfer fees. After block 1098, process 1080 terminates or otherwise returns to a calling process to perform other actions.

If, at decision block 1090, the first fund aggregate does not equal the second fund aggregate, then process 1080 flows from decision block 1090 to block 1092. At block 1092, a difference between the first fund aggregate and the second fund aggregate is determined.

Process 1080 proceeds to block 1094, where funds are transferred between the first fund and the second fund based on the determined difference. If the first fund aggregate is greater than the second fund aggregate, then the determined difference is withdrawn from the first fund and deposited into the second fund. If the second fund aggregate is greater than the first fund aggregate, then the determined difference is withdrawn from the second fund and deposited into the first fund.

Process 1080 continues at block 1096, where the transfer logs for each user associated with the plurality of transfer requests are updated based on the plurality of fund transfer requests. In this way, the transfer logs indicate that money has changed from one fund to another for each particular transfer request, but only the aggregated difference between all of the transfer requests has actually changed funds, which can reduce payment of transfer fees. After block 1096, process 1080 terminates or otherwise returns to a calling process to perform other actions.

Embodiments of the foregoing processes and methods may contain additional acts not shown in FIGS. 10A-10D, may not contain all of the acts shown in FIGS. 10A-10D, may perform acts shown in FIGS. 10A-10D in various orders, may combine acts, and may be modified in various respects. For example, process 1000 in FIG. 10A may perform act 1004 simultaneously with acts 106 and 108, process 1080 in FIG. 10D may perform acts 1086 and 1088 prior to acts 1082 and 1084, etc.

Some embodiments may take the form of or comprise computer program products. For example, according to one embodiment there is provided a computer readable medium comprising a computer program adapted to perform one or more of the methods or functions described above. The medium may be a physical storage medium, such as for example a ROM chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
one or more memories, which, in operation, store instructions; and
one or more processing cores coupled to the one or more memories, which, in operation, execute instructions to perform actions including:
determining an account balance for an account;
displaying the account balance on a computing device; and
while the account balance is being displayed on the computing device for at least a display time period:
determining an accrued interest over a determined period of time based on the account balance and a determined interest rate, wherein the determined period of time is shorter than the display time period and greater than zero;
determining an updated account balance for the account based on the account balance and the accrued interest; and
updating the display of the account balance by displaying a transitional animation from the account balance to the updated account balance.

2. The device of claim 1 wherein the determined period of time is less than one second but greater than zero seconds.

3. The device of claim 1 wherein the one or more processing cores, in operation, execute the instructions to perform actions including:
pausing the displaying of the updated account balance for a determined pause period prior to displaying a second updated account balance based on the updated account balance;
during the determined pause period:
determining a second accrued interest based on the updated account balance and the determined interest rate;
determining the second updated account balance for the account based on the updated account balance and the second accrued interest; and
in response to an end of the determined pause period, updating the display of the updated account balance by displaying the transitional animation from the updated account balance to the second updated account balance.

4. The device of claim 1 wherein the one or more processing cores, in operation, execute the instructions to perform actions including:
determining a least significant digit and a more significant digit that changed values between the account balance and the updated account balance; and
employing the transitional animation to update the least significant digit from a first value for the account balance to a second value for the updated account balance at a first rate that is faster than a second rate for updating the more significant digit from a third value for the account balance to a forth value for the updated account balance.

5. The device of claim 1 wherein the one or more processing cores, in operation, execute the instructions to perform actions including:
receiving a non-interest increase in the account balance; and
determining the updated account balance based on the account balance, the non-interest increase, and the accrued interest.

6. The device of claim 1 wherein the one or more processing cores, in operation, execute the instructions to perform actions including:
determining that the updated account balance includes more digits than the account balance;
updating the display of the account balance by right shifting the displayed account balance based on a change in a number of digits between the account balance and the updated account balance; and
employing the transition animation from the account balance to the updated account balance by updating each digit of the updated account balance from the account balance to the updated account balance.

7. The device of claim 1 wherein the one or more processing cores, in operation, execute the instructions to perform actions including:
determining that a change between the account balance and the updated account balance is less than one cent; and
updating the display of the account balance to include micro-cents.

8. The device of claim 1 wherein the one or more processing cores, in operation, execute the instructions to perform actions including:
determining that a change between the account balance and the updated account balance is greater than one cent; and
updating the display of the account balance to remove a display of micro-cents.

9. The device of claim 1 wherein determining the updated account balance includes determining a real-time balance for display without updating a ledger entry for the account.

10. The device of claim 9 wherein the one or more processing cores, in operation, execute the instructions to perform actions including:
updating the ledger entry at a second determined period of time that is longer than the determined period of time or in response to a deposit or withdrawal from the account.

11. The device of claim 1 wherein determining the accrued interest, determining the updated account balance, and updating the display of the account balance include:
providing, to the computing device, the account balance, the determined interest rate, a number of times interest is compounded per year, and an amount of time that has passed since the account balance was determined; and
instructing the computing device to compute the updated account balance for the determined period of time and update the display of the account balance by displaying the transitional animation from the account balance to the updated account balance.

12. The device of claim 1 wherein the one or more processing cores, in operation, execute the instructions to perform actions including:
displaying a counter from when the updated account balance was determined to when a second updated account balance is to be determined.

13. A method, comprising:
determining an account balance for an account;
displaying the account balance on a computing device; and
while the account balance is being displayed on the computing device for at least a display time period:
determining an accrued interest over a determined period of time based on the account balance and a determined interest rate, wherein the determined period of time is shorter than the display time period and greater than zero;
determining an updated account balance for the account based on the account balance and the accrued interest; and
updating the display of the account balance by displaying a transitional animation from the account balance to the updated account balance.

14. The method of claim 13 wherein the determined period of time is less than one second but greater than zero seconds.

15. The method of claim 13, comprising:
pausing the displaying of the updated account balance for a determined pause period prior to displaying a second updated account balance based on the updated account balance;
during the determined pause period:
determining a second accrued interest based on the updated account balance and the determined interest rate;
determining the second updated account balance for the account based on the updated account balance and the second accrued interest; and
in response to an end of the determined pause period, updating the display of the updated account balance by displaying the transitional animation from the updated account balance to the second updated account balance.

16. The method of claim 13, comprising:
determining a least significant digit and a more significant digit that changed values between the account balance and the updated account balance; and
employing the transitional animation to update the least significant digit from a first value for the account balance to a second value for the updated account balance at a first rate that is faster than a second rate for updating the more significant digit from a third value for the account balance to a forth value for the updated account balance.

17. The method of claim 13, comprising:
receiving a non-interest increase in the account balance; and
determining the updated account balance based on the account balance, the non-interest increase, and the accrued interest.

18. The method of claim 13, comprising:
determining that the updated account balance includes more digits than the account balance;
updating the display of the account balance by right shifting the displayed account balance based on a change in a number of digits between the account balance and the updated account balance; and
employing the transition animation from the account balance to the updated account balance by updating each digit of the updated account balance from the account balance to the updated account balance.

19. The method of claim 13, comprising:
determining that a change between the account balance and the updated account balance is less than one cent; and
updating the display of the account balance to include micro-cents.

20. The method of claim 13, comprising:
determining that a change between the account balance and the updated account balance is greater than one cent; and
updating the display of the account balance to remove a display of micro-cents.

21. The method of claim 13 wherein determining the updated account balance includes determining a real-time balance for display without updating a ledger entry for the account.

22. The method of claim 21, comprising:
updating the ledger entry at a second determined period of time that is longer than the determined period of time or in response to a deposit or withdrawal from the account.

23. The method of claim 13 wherein determining the accrued interest, determining the updated account balance, and updating the display of the account balance include:
providing, to the computing device, the account balance, the determined interest rate, a number of times interest is compounded per year, and an amount of time that has passed since the account balance was determined; and
instructing the computing device to compute the updated account balance for the determined period of time and update the display of the account balance by displaying the transitional animation from the account balance to the updated account balance.

24. The method of claim 13, comprising:
displaying a counter from when the updated account balance was determined to when a second updated account balance is to be determined.

25. A non-transitory computer-readable medium having contents that cause a processor to perform actions, the actions comprising:
determining an account balance for an account;
displaying the account balance on a computing device; and
while the account balance is being displayed on the computing device for at least a display time period:
determining an accrued interest over a determined period of time based on the account balance and a determined interest rate, wherein the determined period of time is shorter than the display time period and greater than zero;
determining an updated account balance for the account based on the account balance and the accrued interest; and
updating the display of the account balance by displaying a transitional animation from the account balance to the updated account balance.

26. The non-transitory computer-readable medium of claim 25 wherein the determined period of time is less than one second but greater than zero seconds.

27. The non-transitory computer-readable medium of claim 25 wherein the contents cause the processor to perform actions, the actions comprising:
pausing the displaying of the updated account balance for a determined pause period prior to displaying a second updated account balance based on the updated account balance;
during the determined pause period:
determining a second accrued interest based on the updated account balance and the determined interest rate;
determining the second updated account balance for the account based on the updated account balance and the second accrued interest; and
in response to an end of the determined pause period, updating the display of the updated account balance by displaying the transitional animation from the updated account balance to the second updated account balance.

28. The non-transitory computer-readable medium of claim 25 wherein the contents cause the processor to perform actions, the actions comprising:
determining a least significant digit and a more significant digit that changed values between the account balance and the updated account balance; and
employing the transitional animation to update the least significant digit from a first value for the account balance to a second value for the updated account balance at a first rate that is faster than a second rate for updating the more significant digit from a third value for the account balance to a forth value for the updated account balance.

29. The non-transitory computer-readable medium of claim 25 wherein the contents cause the processor to perform actions, the actions comprising:
receiving a non-interest increase in the account balance; and
determining the updated account balance based on the account balance, the non-interest increase, and the accrued interest.

30. The non-transitory computer-readable medium of claim 25 wherein the contents cause the processor to perform actions, the actions comprising:
determining that the updated account balance includes more digits than the account balance;
updating the display of the account balance by right shifting the displayed account balance based on a change in a number of digits between the account balance and the updated account balance; and
employing the transition animation from the account balance to the updated account balance by updating each digit of the updated account balance from the account balance to the updated account balance.

31. The non-transitory computer-readable medium of claim 25 wherein the contents cause the processor to perform actions, the actions comprising:
determining that a change between the account balance and the updated account balance is less than one cent; and
updating the display of the account balance to include micro-cents.

32. The non-transitory computer-readable medium of claim 25 wherein the contents cause the processor to perform actions, the actions comprising:
determining that a change between the account balance and the updated account balance is greater than one cent; and
updating the display of the account balance to remove a display of micro-cents.

33. The non-transitory computer-readable medium of claim 25 wherein determining the updated account balance includes determining a real-time balance for display without updating a ledger entry for the account.

34. The non-transitory computer-readable medium of claim 33 wherein the contents cause the processor to perform actions, the actions comprising:
updating the ledger entry at a second determined period of time that is longer than the determined period of time or in response to a deposit or withdrawal from the account.

35. The non-transitory computer-readable medium of claim 25 wherein determining the accrued interest, determining the updated account balance, and updating the display of the account balance include:
providing, to the computing device, the account balance, the determined interest rate, a number of times interest is compounded per year, and an amount of time that has passed since the account balance was determined; and
instructing the computing device to compute the updated account balance for the determined period of time and update the display of the account balance by displaying the transitional animation from the account balance to the updated account balance.

36. The non-transitory computer-readable medium of claim 25 wherein the contents cause the processor to perform actions, the actions comprising:
displaying a counter from when the updated account balance was determined to when a second updated account balance is to be determined.
